(19) United States
(12) Patent Application Publication
(10) Pub. No.: US 2024/0415099 A1
(43) Pub. Date: Dec. 19, 2024

(54) POULTRY WALKING HARNESS AND METHOD OF MAKING SAME

(71) Applicant: Crazy K Farm Pet and Poultry Products, LLC., Hempstead, TX (US)

(72) Inventor: Tobi Kosanke, Hempstead, TX (US)

(73) Assignee: Crazy K Farm Pet and Poultry Products, LLC., Hempstead, TX (US)

(21) Appl. No.: 18/745,827

(22) Filed: Jun. 17, 2024

Related U.S. Application Data
(60) Provisional application No. 63/521,405, filed on Jun. 16, 2023.

(51) Int. Cl. A01K 27/00

(52) U.S. Cl. CPC A01K 27/002

(57) ABSTRACT

A poultry walking harness includes a body portion, neck straps connected to the body portion and each extending in a forward direction, a leash connector connected to the neck straps to form, along with the neck straps and the body portion, a neck opening shaped to surround a neck of poultry, forward securing straps connected to at least one of the neck straps and the leash connector and extending in the forward direction and rear securing straps connected to the body portion and extending in a rearward direction, the forward and rear securing straps having removably securable connectors configured to connect to one another and, thereby, secure the body portion to a body of the poultry.

### CROSS-REFERENCE TO RELATED APPLICATIONS

This application claims the priority, under 35 U.S.C. § 119, of copending U.S. Provisional Patent Application No. 63/521,405, filed Jun. 16, 2023; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of animal safety and protection. The present disclosure relates to a poultry walking harness.

### BACKGROUND OF THE INVENTION

Pet poultry that are unable to free-range live and forages results in a lack of exercise and poor health. However, to keep a pet contained, a harness is required. In general, harnesses are relatively easy for poultry to escape from because poultry, especially chickens, have flexible necks and can pull their head down to their chest. Using, for example, a dog or cat harness that is intended to put pressure on the chest to control the animal, that pressure on a chicken would be against the crop. If there is any liquid in the crop (which occurs after a chicken had taken a drink of water), that pressure would push the water up their throat and back down into their lungs, causing death of the chicken. This must be avoided.

### SUMMARY OF THE INVENTION

The systems, apparatuses, and methods described provide a poultry walking harness that overcomes the hereinafore-mentioned disadvantages of the heretofore-known devices and methods of this general type and that provide such features with a harness that is difficult for poultry to escape from, is non-constrictive, and fastens securely. The configurations and methods disclosed herein describe and show a poultry walking harness the is able to fit properly and is neither constrictive nor uncomfortable for the poultry to wear, especially around the crop area. It is important to avoid pressure on the chest of a chicken. The poultry walking harness provides a safe level of compression by stretching and spreading chest pressure over a large area of the chest and, in particular, not centering it on the crop. The poultry walking harness includes a shoulder attachment that, together with the body and straps, does not create any dangerous pressure points on the pet's crop and accommodates the crop with supportive pressure. This support eliminates the possibility of creating dangerous pressure points on the pet's crop, which could result in injury, poor health, and death.

The poultry walking harness secures onto poultry in variable ways that accommodate different sizes of bird to eliminate the requirement of a variety of separate harness sizes (e.g., sm, med, lg, xl, xxl) to fit different sizes of poultry. The poultry walking harness enables poultry owners to safely exercise their poultry and is difficult for poultry to escape from.

With the foregoing and other objects in view, there is provided, a poultry walking harness comprising a body portion, neck straps connected to the body portion and each extending in a forward direction, a leash connector connected to the neck straps to form, along with the neck straps and the body portion, a neck opening shaped to surround a neck of poultry, forward securing straps connected to at least one of the neck straps and the leash connector and extending in the forward direction and rear securing straps connected to the body portion and extending in a rearward direction, the forward and rear securing straps having removably securable connectors configured to connect to one another and, thereby, secure the body portion to a body of the poultry.

With the objects in view, there is also provided a poultry walking harness comprising a body portion, neck straps connected to the body portion and each extending in a forward direction, a leash connector connected to the neck straps to form, along with the neck straps and the body portion, a neck opening shaped to surround a neck of poultry, at least one rear securing loop connected to the body portion, forward securing straps each having a tail portion and an intermediate portion, each connected to at least one of the neck straps and the leash connector, each extending in the forward direction from the leash connector and each having a length sufficient to wrap around a body of the poultry and, thereafter, pass the respective tail portion through the at least one rear securing loop, each of the tail portions configured to removably connect to an intermediate portion and, thereby, secure the body portion to a body of the poultry.

With the objects in view, there is also provided a poultry walking harness, comprising a body portion, neck straps connected to the body portion and each extending in a forward direction, a leash connector connected to the neck straps to form, along with the neck straps and the body portion, a neck opening shaped to surround a neck of poultry, at least one forward securing loop connected to the body portion, rear securing straps each having a tail portion and an intermediate portion, each connected to the body portion and extending in a rearward direction from the body portion, and each having a length sufficient to wrap around a body of the poultry and, thereafter, pass the respective tail portion through the at least one forward securing loop, each of the tail portions configured to removably connect to an intermediate portion and, thereby, secure the body portion to a body of the poultry.

In accordance with another feature, the body portion comprises opposing front and rear edges that, together, define a body portion width and opposing left and right side edges that, together, define a body portion length.

In accordance with a further feature, the body portion has a length and a width and is longer in the length than in the width.

In accordance with an added feature, the width W is between one of approximately 3 cm (1.18″) and approximately 31 cm (12.2″), approximately 3 cm (1.18″) and approximately 20 cm (7.87″), approximately 5 cm (1.97″) and approximately 15 cm (5.9″), and approximately 5 cm (1.97″) and approximately 10 cm (3.94″), and the length L is between one of approximately 5 cm (1.97″) and approximately 61 cm (24″), approximately 5 cm (1.97″) and approximately 31 cm (12.2″), approximately 7 cm (2.76″) and approximately 20 cm (7.87″), and approximately 7 cm (2.76″) and approximately 15 cm (5.9″).

In accordance with an additional feature, the body portion is one of rectangular shaped, rounded rectangular shaped, V-shaped, and ovular.

In accordance with yet another feature, the body portion has a front edge; and the neck straps are connected to the front edge, comprise neck strap terminations connected to the leash connector and extend from the front edge of the body portion to the neck strap terminations.

In accordance with yet a further feature, the body portion has a rear edge and the rear securing straps are connected to the rear edge.

In accordance with yet an added feature, the neck straps are one of integral with the body portion and removably secured to the body portion, the leash connector is one of integral with the neck straps and removably secured to the neck straps, the forward securing straps are one of integral with the leash connector and removably secured to the leash connector, and the rear securing straps are one of integral with the body portion and removably secured to the body portion.

In accordance with yet an additional feature, the neck straps are removably secured to the body portion with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

In accordance with again another feature, the leash connector is removably secured to the neck straps with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

In accordance with again a further feature, the forward securing straps are removably secured to the leash connector with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

In accordance with again an added feature, the rear securing straps are removably secured to the body portion with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

In accordance with again an additional feature, the forward securing straps are connected to the leash connector one of side-by-side and spaced apart from one another.

In accordance with still another feature, the forward securing straps are connected to the neck straps.

In accordance with still a further feature, the rear securing straps are connected to the body portion one of side-by-side and spaced apart from one another.

In accordance with still an added feature, the body portion has a length defining a length axis, the neck straps are at respective angles to the length axis, and the rear securing straps are at respective angles to the length axis.

In accordance with still an additional feature, the leash connector comprises a loop 64 shaped and configured to be removably connected to a clasp of a pet leash.

In accordance with a concomitant feature, the body portion, the neck straps, the forward and rear securing straps, and the leash connector are comprised of a material selected from at least one of latex, elastic, LYCRA®, denim, silk, cotton, fleece, rubber, polyester, acetate, nylon, RAYON®, DACRON®, ORLON®, CORDURA®, lyocell, spandex, microfiber, artificial silk, mixtures thereof, and combinations thereof.

Although the systems, apparatuses, and methods are illustrated and described herein as embodied in a poultry harness and methods of making same, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a perspective view from above an exemplary embodiment of a poultry walking harness laid flat;

FIG. 2 is a perspective view from above an exemplary embodiment of a poultry walking harness worn on a duck;

FIG. 3 is a perspective view from above an exemplary embodiment of a poultry walking harness worn on a chicken;

FIG. 4 is a perspective view from the right side of the poultry walking harness of FIG. 3;

FIG. 5 is a perspective view from above a front of an exemplary embodiment of a poultry walking harness worn on a chicken;

FIG. 6 is a perspective view from above a left front side of the poultry walking harness of FIG. 5;

FIG. 7 is a perspective view from above an exemplary embodiment of a poultry walking harness laid flat;

FIG. 8 is a perspective view from above an exemplary embodiment of a poultry walking harness laid flat; and

FIG. 9 is a perspective view from above an exemplary embodiment of a poultry walking harness laid flat.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider them as being the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

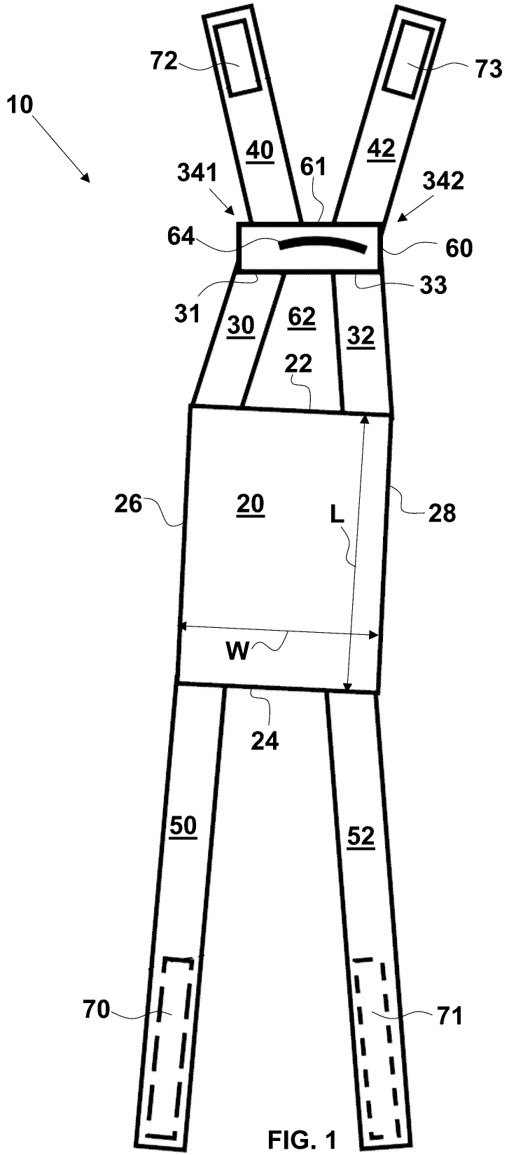

Described now are exemplary embodiments. Referring now to the figures of the drawings in detail and first, particularly to FIG. 1, there is shown a first exemplary embodiment of a poultry walking harness 10 having a body portion 20, neck straps 30, 32, forward securing straps 40, 42, rear securing straps 50, 52, and a leash connector 60.

The body portion 20 has opposing edges 22, 24 (e.g., front and rear) that, together, define a body portion width W. In an exemplary embodiment, the width W is between approximately 3 cm (1.18″) and approximately 31 cm (12.2″), between approximately 3 cm (1.18″) and approximately 20 cm (7.87″), more particularly, between approximately 5 cm (1.97″) and approximately 15 cm (5.9″), in particular, between approximately 5 cm (1.97″) and approximately 10 cm (3.94″). The body portion 20 has opposing side edges 26, 28 (e.g., left and right) that, together, define a body portion length L and, thereby, a length axis. In an exemplary embodiment, the length L is between approximately 5 cm (1.97″) and approximately 61 cm (24″), between approximately 5 cm (1.97″) and approximately 31 cm (12.2″), more particularly, between approximately 7 cm (2.76″) and approximately 20 cm (7.87″), in particular, between approximately 7 cm (2.76″) and approximately 15 cm (5.9″). The exemplary embodiment of FIG. 1 depicts a rectangular shaped body portion 20. However, in an alternative embodiment, the corners can be rounded to form a rounded rectangle. In another alternative embodiment, the body portion 20 can be ovular. In another alternative embodiment, the body portion 20 can be V-shaped. In any exemplary embodiment, the length L corresponds to a longest portion of the shape in a front-to-back direction and the width W corresponds to a longest portion of the shape in a left-to-right direction. For example, in an ovular-shaped body portion 20, the front-to-back direction is the major axis of the oval and a left-to-right direction is the minor axis of the oval.

A pair of neck straps 30, 32 extend from the front edge 22 of the body portion 20 to neck strap terminations 31, 33. The neck straps 30, 32 can be integral with the body portion 20 or can removably secured to the body portion 20, for example, with hook-and-loop fasteners.

A pair of forward securing straps 40, 42 are respectively connected to one of the pair of neck strap terminations 31, 33 to define two connection areas 341, 342. The connection of each of the forward securing straps 40, 42 to the neck strap terminations 31, 33 can be integral or can removably secured thereto, for example, with hook-and-loop fasteners. These two connection areas 341, 342 are connected to one another by the leash connector 60. As with other connections, they can be integral or can removably secured. Accordingly, the front edge 22, the neck straps 30, 32, and the leash connector 60 together define a closed-off interior opening 62.

In an exemplary embodiment, the leash connector 60 includes a loop 64 that is shaped and configured to be removably connected to a clasp of a pet leash 70.

A pair of rear securing straps 50, 52 are respectively connected to the rear edge 24 of the body portion 20, the rear securing straps 50, 52 extending in a rearward direction opposite the extension direction of the neck straps 30, 32. This direction is not necessarily only in the 180° opposite direction, either of the straps 30, 32, 50, 52 can be (and are shown) at angles to the length L direction of the body portion 20; each individual strap can be at different or similar angles, for example, between 1° and 45°, more particularly, between 1° and 25°, in particular, between 1° and 15°.

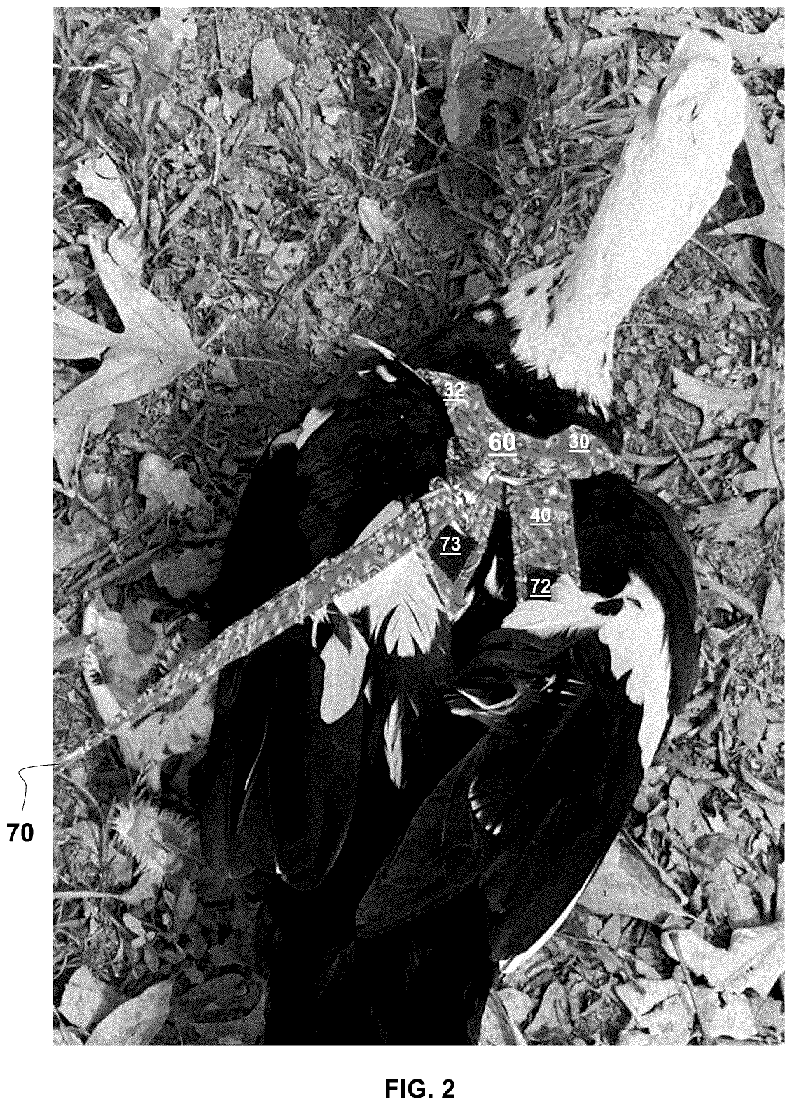

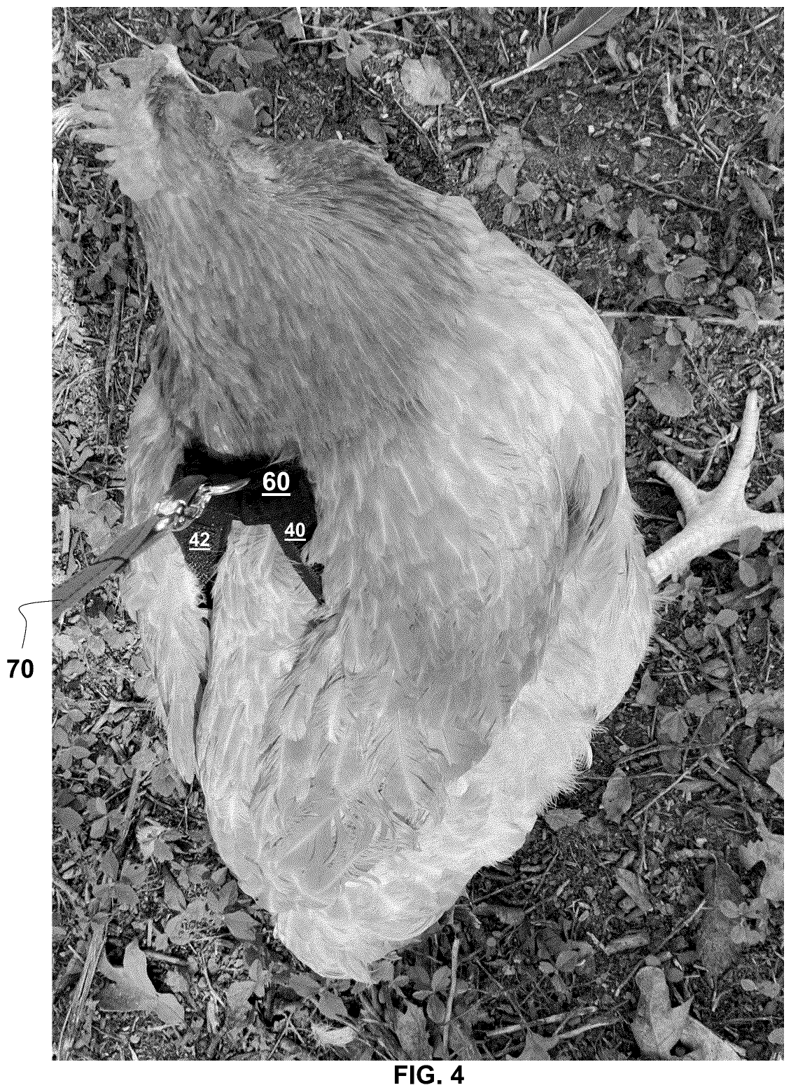

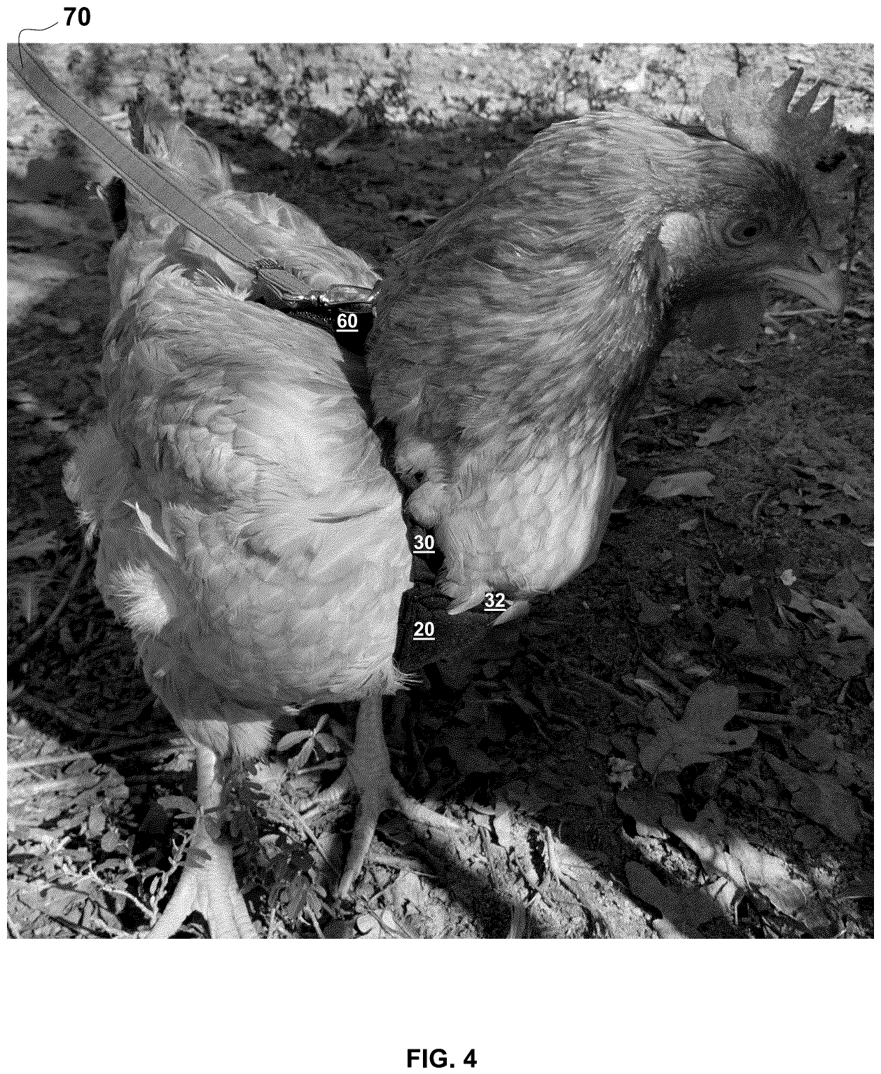

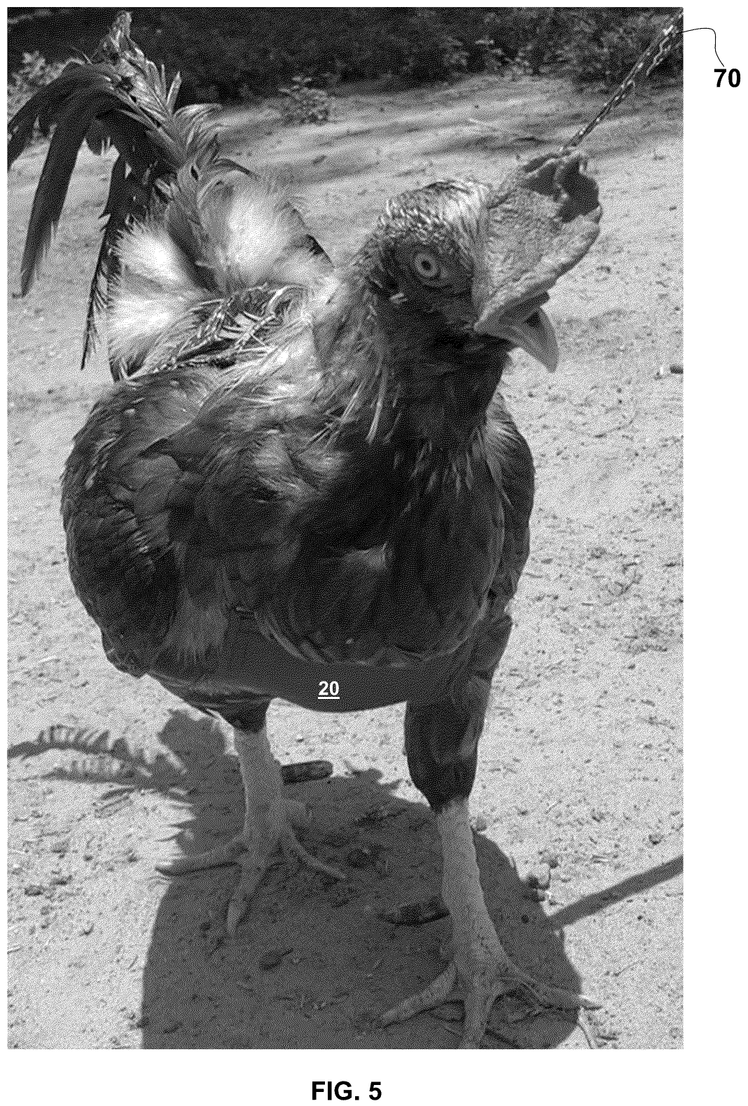

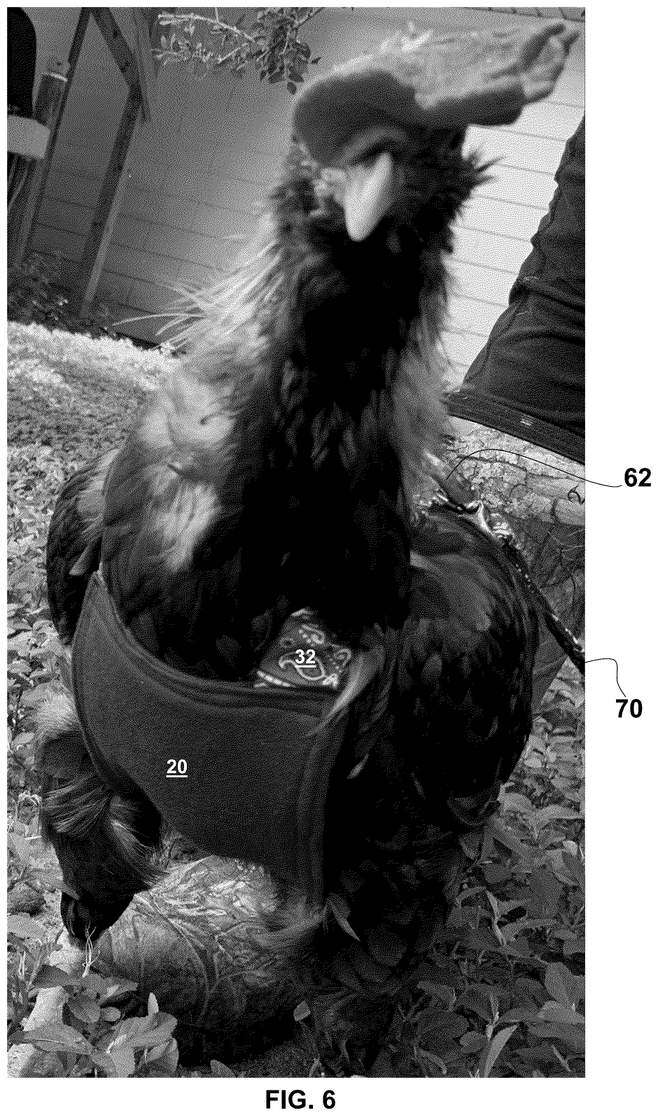

This exemplary embodiment of the poultry walking harness 10 is placed to be worn by a bird, in a first step, by inserting the bird's neck through the interior opening 62 with the loop 64 on a side of the leash connector 60 facing away from the back of the bird and with the leash connector 60 behind the head of the bird on its back, as shown, for example, in FIGS. 2 through 6. The lengths of the respective pairs of forward and rear securing straps 40, 42, 50, 52 will determine how the poultry walking harness 10 is removably secured on the bird. In the exemplary embodiment where the forward securing straps 40, 42 are longer than the rear securing straps 50, 52, the forward securing straps 40, 42 are, in a second step, each guided/pulled up above the bird, over and around the top of the bird, and then behind and under the wings to, then, be fastened to a respective one of the rear securing straps 50, 52. Alternatively, in the exemplary embodiment where the rear securing straps 50, 52 are longer than the forward securing straps 40, 42, the forward securing straps 40, 42 will lie on the bird's back and the rear securing straps 50, 52 will, in a second step, each be guided/pulled below the bird, around from the bottom of the bird from behind the wings, and over the wings to, then, be fastened to a respective one of the forward securing straps 40, 42. These pairs of securing straps 40, 42, 50, 52 can be connected in a straight configuration along the bird's body or in a diagonal configuration across the bird's body. FIGS. 2 to 6 illustrate the exemplary embodiment where the rear securing straps 50, 52 are longer than the forward securing straps 40, 42. Therefore, the forward securing straps 40, 42 lie on the back or top of the bird's body and the rear securing straps 50, 52 are guided from between the bird's legs under the bird behind, around, and above the bird's back to connect to the forward securing straps 40, 42 to make straight connections along the bird's back. Fastening of the securing straps 40, 42, 50, 52 across the bird's back occur by removably connecting together two halves of a two-part removable fastener 70-72, 71-73, as shown in FIGS. 2 to 6. In this straight connection, the removable fastener 70 is connected to the removable fastener 72 and the removable fastener 71 is connected to the removable fastener 73. In a diagonal, non-illustrated connection, the removable fastener 70 is connected to the removable fastener 73 and the removable fastener 71 is connected to the removable fastener 72.

Removable securing fasteners are described herein in one exemplary embodiment of hook-and-loop fasteners. Equally applicable in all embodiments of the poultry walking harness are removably securing fasteners including snap fasteners, buttons, zip fasteners, hook and eye fasteners, magnetic fasteners, zippers, string ties, mushroom re-closable fasteners, and/or removable adhesive tapes.

An exemplary method of making the poultry walking harness 10 includes connecting a strap 30 forming the left side of the neck loop to the left side of the front edge 22 of the body portion 20. A strap 32 forming the right side of the neck loop is connected to the right side of the front edge 22 of the body portion 20. To finish or enclose the neck loop, a leash connector 60 connects the neck strap terminations 31, 33 to one another. In an alternative non-illustrated configuration, the neck loop is formed by a single annular strap having a central opening shaped to fit therein the poultry's head and neck to lie against the body or the base of the neck when worn. The neck loop has two opposing portions with straps connected thereto to have one pair lie on the top of the bird's body and another pair lie under the body with the pairs connected together to secure the poultry walking harness 10 on the bird without adverse compressive force on the crop. Alternatively, the forward side can have one strap configured to removably connect to two separate rear straps or the rear side can have one strap configured to removably connect to two separate forward straps.

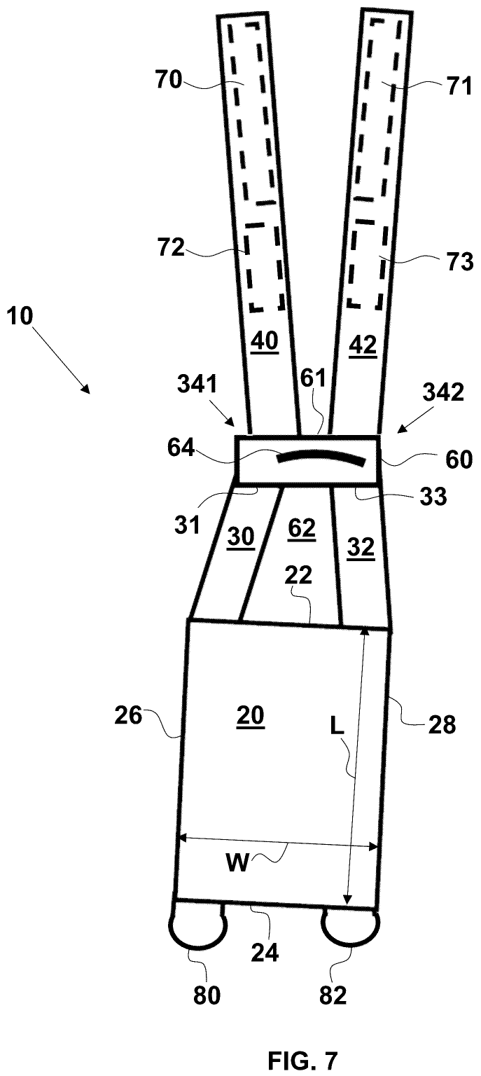

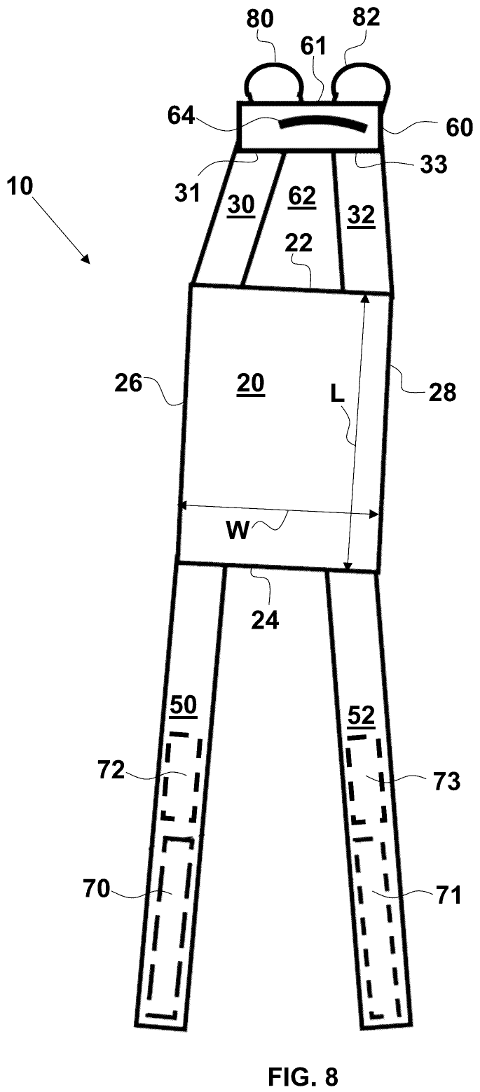

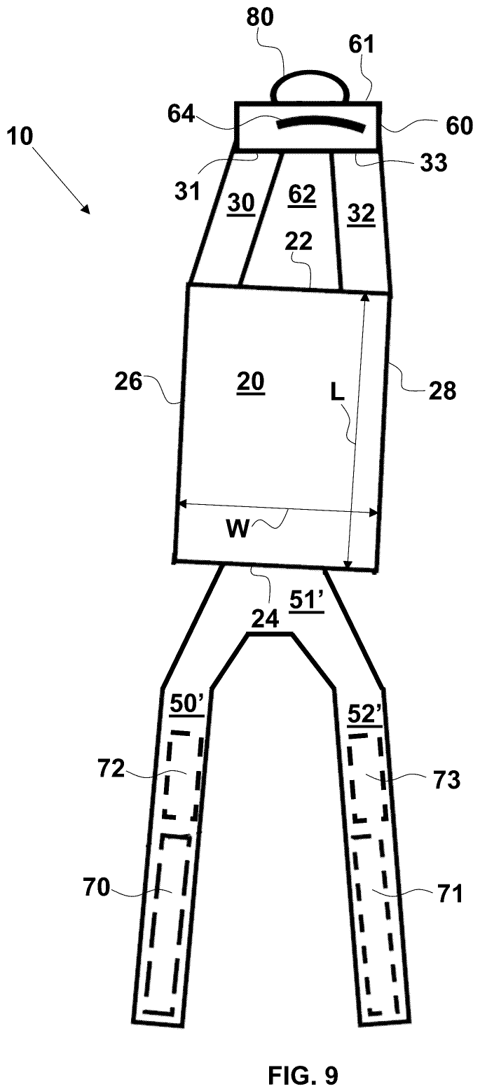

In a further alternative configuration, one of the pairs of straps is replaced with one or a pair of rings and the other of the pairs of straps is sized longer to be able to enter one ring or one of the pair of rings, to pass through the ring, and to fold over a portion of the ring to extend back over the longer strap. Examples of this configuration are shown in FIGS. 7, 8, and 9. The end of each strap so configured is provided with a removable fastener 70-72, 71-73 such that, after being passed through a respective ring 80, 82 and folded back along itself, the two portions of the longer strap (40, 42 in FIG. 7; 50, 52 in FIGS. 8 and 9) touching one another removably secure together. In an example where the removable fastener is a hook-and-loop fastener, adjacent the distal end of each strap is one part 70, 71 (e.g., the hooks) of the fastener and the other part 72, 73 (e.g., the loops) of the fastener extends over a distance from the distal end of the strap. In an alternative exemplary embodiment, the longer straps 50, 52 can merge at the base into a Y-shaped strap as shown in FIG. 9.

In a particular exemplary embodiment illustrated in FIG. 7, the poultry walking harness 10 includes a body portion 20, neck straps 30, 32 connected to the body portion 20, each of the neck straps extending in a forward direction, and a leash connector 60 connected to the neck straps 30, 32 to form, along with the neck straps 30, 32 and the body portion 20, a neck opening 62 shaped to surround a neck of poultry. Forward securing straps 40, 42 each have a tail portion and an intermediate portion, each are connected to the neck straps 30, 32, the leash connector 60, or both, and each extend in the forward direction from the leash connector 60. Instead of rear straps, there is provided at least one rear securing loop 80, 82 connected to the body portion 20. Accordingly, each of the forward securing straps 40, 42 have a length sufficient to wrap around a body of the poultry and, thereafter, pass the respective tail portion of the forward securing straps 40, 42 through the at least one rear securing loop 80, 82. Each of the tail portions (e.g., 70, 71) of the forward securing straps 40, 42 is configured to removably connect to a respective intermediate portion (e.g., 72, 73) and, thereby, secure the body portion 20 to a body of the poultry without adverse compressive force on the crop. The removable connection can be any of hook-and-loop fasteners, snap fasteners, buttons, zip fasteners, hook and eye fasteners, magnetic fasteners, zippers, string ties, mushroom re-closable fasteners, removable adhesive tapes, and mixtures or combinations of these.

In a further particular exemplary embodiment illustrated in FIGS. 8 and 9, the poultry walking harness 10 includes a body portion 20, neck straps 30, 32 connected to the body portion 20, each of the neck straps extending in a forward direction, and a leash connector 60 connected to the neck straps 30, 32 to form, along with the neck straps 30, 32 and the body portion 20, a neck opening 62 shaped to surround a neck of poultry. Rear securing straps 50, 52 each have a tail portion and an intermediate portion and each are connected to the body portion 20 and extend in a rearward direction from the body portion 20. Instead of forward straps, the poultry walking harness 10 has at least one forward securing loop 80, 82 connected to the body portion 20. Accordingly, each of the rear securing straps 50, 52 has a length sufficient to wrap around a body of the poultry and, thereafter, pass the respective tail portion of the rear securing straps 50, 52 through the at least one forward securing loop 80, 82. Each of the tail portions (e.g., 70, 71) of the rear securing straps 50, 52 is configured to removably connect to an intermediate portion (e.g., 72, 73) and, thereby, secure the body portion 20 to a body of the poultry without adverse compressive force on the crop. As in other embodiments, the removable connection can be any of hook-and-loop fasteners, snap fasteners, buttons, zip fasteners, hook and eye fasteners, magnetic fasteners, zippers, string ties, mushroom re-closable fasteners, removable adhesive tapes, and mixtures or combinations of these.

In another exemplary embodiment illustrated in FIG. 9, one of the pairs of straps (in this case, the forward straps) can be replaced with one or more rings (in this case, one ring 80) and the other pair of straps (in this case, one rear securing straps 51′) that is long enough to extend around the body of the bird and then split, in a Y-shape, to provide respective tail portions (e.g., 70, 71) each long enough to pass through the one or more rings and wrap therearound and extend in the opposite direction to, then, be removably secured to the respective strap (e.g., 72, 73) in a fold-over configuration. In a non-illustrated, similar exemplary embodiment, one of the pairs of straps can be replaced with two rings and the other pair of straps is a single strap secured to the body 20 or to the leash connector 60 that is long enough to extend around the body of the bird and then split, in a Y-shape, to provide respective tail portions each long enough to pass through one of the two rings and wrap respectively therearound and extend in the opposite direction to, then, be removably secured to the respective strap in a fold-over configuration.

In an exemplary embodiment, a pair of forward securing straps 40, 42 are connected to the forward portion of the neck loop, which can be at the neck strap terminations 31, 33, at a forward edge 61 of the leash connector 60, or at one of each. These strap connections are adjacent one another and can be either side-by-side next to one another or spaced apart from one another. They also can combine into one strap adjacent the base of the strap as shown, for example, in FIG. 9.

In an exemplary embodiment, a rear securing strap 50 is connected to the left side of the rear edge 24 of the body portion 20 and another rear securing strap 52 is connected to the right side of the rear edge 24 of the body portion 20. These strap connections are adjacent one another and can be either side-by-side next to one another or spaced apart from one another. They also can combine into one strap adjacent the base of the strap as shown, for example, in FIG. 9.

In the exemplary configuration of the forward and rear securing straps 40, 42, 50, 52, the pairs of securing straps fasten to each other with hook-and-loop fasteners. In an alternative exemplary embodiment, the forward and rear securing straps 40, 42, 50, 52 are removably fastened together by tying them together.

As set forth above, all or some of the connections can be removable connections and all or some of the connections can be permanent or integral connections.

The body portion 20 and each of the securing straps 30, 32, 40, 42, 50, 52 and the leash connector 60 are comprised of at least one of the materials including, but not limited to, latex, elastic, LYCRA®, denim, silk, cotton, fleece, rubber, polyester, acetate, nylon, RAYON®, DACRON®, ORLON®, CORDURA®, lyocell, spandex, microfiber, artificial silk, and mixtures or combinations thereof.

All the elements in the exemplary embodiment of the poultry walking harness 10 make a single harness that is safe, secure, and comfortable for many different sizes of poultry.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A poultry walking harness, comprising:
a body portion;
neck straps connected to the body portion and each extending in a forward direction;
a leash connector connected to the neck straps to form, along with the neck straps and the body portion, a neck opening shaped to surround a neck of poultry;
forward securing straps:
connected to at least one of:
the neck straps; and
the leash connector; and
extending in the forward direction; and
rear securing straps connected to the body portion and extending in a rearward direction, the forward and rear securing straps having removably securable connectors configured to connect to one another and, thereby, secure the body portion to a body of the poultry.

2. The harness according to claim 1, wherein the body portion comprises:
opposing front and rear edges that, together, define a body portion width; and
opposing left and right side edges that, together, define a body portion length.

3. The harness according to claim 1, wherein the body portion has a length and a width and is longer in the length than in the width.

4. The harness according to claim 2, wherein:
the width W is between one of:
approximately 3 cm (1.18″) and approximately 31 cm (12.2″);
approximately 3 cm (1.18″) and approximately 20 cm (7.87″);
approximately 5 cm (1.97″) and approximately 15 cm (5.9″); and
approximately 5 cm (1.97″) and approximately 10 cm (3.94″); and
the length L is between one of:
approximately 5 cm (1.97″) and approximately 61 cm (24″);
approximately 5 cm (1.97″) and approximately 31 cm (12.2″);
approximately 7 cm (2.76″) and approximately 20 cm (7.87″); and
approximately 7 cm (2.76″) and approximately 15 cm (5.9″).

5. The harness according to claim 1, wherein the body portion is one of rectangular shaped, rounded rectangular shaped, V-shaped, and ovular.

6. The harness according to claim 1, wherein:
the body portion has a front edge; and
the neck straps:
are connected to the front edge;
comprise neck strap terminations connected to the leash connector; and
extend from the front edge of the body portion to the neck strap terminations.

7. The harness according to claim 1, wherein:
the body portion has a rear edge; and
the rear securing straps are connected to the rear edge.

8. The harness according to claim 1, wherein:
the neck straps are one of integral with the body portion and removably secured to the body portion;
the leash connector is one of integral with the neck straps and removably secured to the neck straps;
the forward securing straps are one of integral with the leash connector and removably secured to the leash connector; and
the rear securing straps are one of integral with the body portion and removably secured to the body portion.

9. The harness according to claim 1, wherein the neck straps are removably secured to the body portion with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

10. The harness according to claim 1, wherein the leash connector is removably secured to the neck straps with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

11. The harness according to claim 1, wherein the forward securing straps are removably secured to the leash connector with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

12. The harness according to claim 1, wherein the rear securing straps are removably secured to the body portion with removably securing fasteners including at least one of hook-and-loop fasteners, snap fasteners, buttons, zip fasteners, hook and eye fasteners, magnetic fasteners, zippers, string ties, mushroom re-closable fasteners, removable adhesive tapes, and mixtures thereof.

13. The harness according to claim 1, wherein the forward securing straps are connected to the leash connector one of side-by-side and spaced apart from one another.

14. The harness according to claim 1, wherein the forward securing straps are connected to the neck straps.

15. The harness according to claim 1, wherein the rear securing straps are connected to the body portion one of side-by-side and spaced apart from one another.

16. The harness according to claim 1, wherein:
the body portion has a length defining a length axis;
the neck straps are at respective angles to the length axis; and
the rear securing straps are at respective angles to the length axis.

17. The harness according to claim 1, wherein the leash connector comprises a loop 64 shaped and configured to be removably connected to a clasp of a pet leash.

18. The harness according to claim 1, wherein the body portion, the neck straps, the forward and rear securing straps, and the leash connector are comprised of a material selected from at least one of latex, elastic, LYCRA®, denim, silk, cotton, fleece, rubber, polyester, acetate, nylon, RAYON®, DACRON®, ORLON®, CORDURA®, lyocell, spandex, microfiber, artificial silk, mixtures thereof, and combinations thereof.

19. A poultry walking harness, comprising:
a body portion;
neck straps connected to the body portion and each extending in a forward direction;
a leash connector connected to the neck straps to form, along with the neck straps and the body portion, a neck opening shaped to surround a neck of poultry;
at least one rear securing loop connected to the body portion; and
forward securing straps:
each having a tail portion and an intermediate portion;
each connected to at least one of the neck straps and the leash connector;
each extending in the forward direction from the leash connector; and
each having a length sufficient to wrap around a body of the poultry and, thereafter, pass the respective tail portion through the at least one rear securing loop, each of the tail portions configured to removably connect to an intermediate portion and, thereby, secure the body portion to a body of the poultry.

20. A poultry walking harness, comprising:
a body portion;
neck straps connected to the body portion and each extending in a forward direction;
a leash connector connected to the neck straps to form, along with the neck straps and the body portion, a neck opening shaped to surround a neck of poultry;
at least one forward securing loop connected to the body portion; and
rear securing straps:
each having a tail portion and an intermediate portion;
each connected to the body portion and extending in a rearward direction from the body portion; and
each having a length sufficient to wrap around a body of the poultry and, thereafter, pass the respective tail portion through the at least one forward securing loop, each of the tail portions configured to removably connect to an intermediate portion and, thereby, secure the body portion to a body of the poultry.
